(19) United States
(12) Patent Application Publication
(10) Pub. No.: US 2025/0271654 A1
(43) Pub. Date: Aug. 28, 2025

(54) SYSTEMS AND METHODS FOR SAMPLE POSITIONING TO FACILITATE MICROSCOPY

(71) Applicant: The Administrators of the Tulane Educational Fund, New Orleans, LA (US)

(72) Inventors: Jonathon Quincy Brown, New Orleans, LA (US); Samuel Jacob Leuthy, New Orleans, LA (US); Max Sebastian Cooper, New Orleans, LA (US)

(21) Appl. No.: 19/207,468

(22) Filed: May 14, 2025

Related U.S. Application Data
(63) Continuation of application No. 17/603,407, filed on Oct. 13, 2021.
(60) Provisional application No. 62/835,874, filed on Apr. 18, 2019.

(51) Int. Cl. G02B 21/26; G01N 21/64; G02B 21/16

(52) U.S. Cl. CPC G02B 21/26; G01N 21/6428; G01N 21/6458; G02B 21/16; G01N 2021/6439

(57) ABSTRACT

In order to remove the need for manual re-positioning of a sample (e.g., a tissue sample) on a microscope stage, systems and methods for sample positioning are described. A sample can be attached to a tissue positioning device. Then a microscope can be used to take a plurality of microscopy images (e.g., 2-dimensional, 3-dimensional, etc.) of a surface of the sample in a rotational geometry using the tissue positioning device to facilitate the microscopy.

### RELATED APPLICATIONS

This application is a continuation of U.S. patent application Ser. No. 17/603,407 which is a 371 of PCT/US2020/028948, filed Apr. 20, 2020, which claims priority to U.S. Provisional Application Ser. No. 62/835,874, filed Apr. 18, 2019, entitled “A Device for Automated Tissue Positioning for Microscopy”. The entirety of this provisional application is hereby incorporated by reference for all purposes.

### GOVERNMENT SUPPORT

This invention was made with U.S. government support under 1R33CA196457 and R21CA159936 awarded by the National Institutes of Health (NIH) National Cancer Institute (NCI). The government has certain rights in this invention.

### TECHNICAL FIELD

The present disclosure relates generally to microscopy and, more specifically, to systems and methods for sample positioning to facilitate microscopy (e.g., 2-dimensional microscopy, 3-dimensional microscopy, etc.).

### BACKGROUND

Prostate cancer is the most common form of cancer in males, with one in nine males developing prostate cancer during their lifetime. Many therapies exist for the treatment of prostate cancer, including external beam radiation, radioactive seed implants (brachytherapy), hormonal therapy, chemotherapy, and surgery. Radical prostatectomy, a common front-line curative approach to non-metastatic prostate cancer, is a surgical procedure that involves the total removal of the prostate gland, including seminal vesicles and ductus deferens, as well as surrounding tissue as needed to achieve local control of cancer spread beyond the prostate borders. The success of a radical prostatectomy depends on complete removal of the tumor at the removed tissue surface. Unfortunately, small bits of tumor are often left behind in the patient (e.g., in as many as 50% of surgeries in patients with late stage prostate cancer). However, an overly radical surgery can lead to complications, including impotence, incontinence, pain, and suffering.

Current methods for studying the tissue surface, such as frozen section analysis (FSA) and, the gold standard, fixed paraffin embedded (FFPE) permanent histopathology, tend to be labor and time intensive, as well as destructive. Non-destructive and more rapid alternatives, such as microscopy procedures, can be used as an alternative to the current gold standard. However, in order to visualize the entire surface of the removed tissue, microscopy requires manual re-positioning of the prostate organ on the microscope stage, leading to a prolonged time and a risk areas of the surface being missed.

### SUMMARY

The present disclosure relates to systems and methods for sample positioning to facilitate microscopy (e.g., 2-dimensional microscopy, 3-dimensional microscopy, etc.). Notably, when imaging the sample surface, the systems and methods remove the need for manual re-positioning of the sample, leading to a faster microscopy procedure with a reduced risk for areas of the sample surface being missed.

In an aspect, the present disclosure can include a system that can be used to position a sample to facilitate microscopy (e.g., 2-dimensional microscopy, 3-dimensional microscopy, etc.) of the sample surface. The system can include a tissue positioning device, which can include a tissue holding mechanism configured to hold at least a portion of a sample (e.g., a tissue sample) and a motorized mechanism that includes at least one motor that is configured to raise, lower, and/or rotate the tissue holding mechanism. The tissue holding mechanism can include at least two portions that can be configured to be secured in joints of the motorized mechanism. The system can also include a microscope that can be configured to image a surface of the sample in a plurality of configurations to provide a visualization of at least a portion of the sample.

In another aspect, the present disclosure can include a method for sample positioning to facilitate microscopy (e.g., 2-dimensional microscopy, 3-dimensional microscopy, etc.) of the sample surface. The method can include attaching a sample (e.g., a tissue sample) to a tissue positioning device; and using a microscope to take a plurality of microscopy images of a surface (e.g., a 2-dimensional surface, a 3-dimensional volume, or the like) of the sample in a rotational geometry using the tissue positioning device.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a schematic diagram showing an example of a system that can be used for sample positioning to facilitate microscopy (e.g., 2-dimensional microscopy, 3-dimensional microscopy, etc.) in accordance with an aspect of the present disclosure;

FIG. 2 shows a top view of an example of the tissue positioning tool of FIG. 1;

FIG. 3 is a process flow diagram illustrating a method for sample positioning to facilitate microscopy (e.g., 2-dimensional microscopy, 3-dimensional microscopy, etc.) in accordance with another aspect of the present disclosure;

FIG. 4 is a process flow diagram illustrating a method for using microscopy images in accordance with another aspect of the present disclosure;

FIG. 5 is a process flow diagram illustrating a method for imaging a labeled sample in accordance with another aspect of the present disclosure;

FIG. 6 is a process flow diagram illustrating a method for performing microscopy in accordance with another aspect of the present disclosure;

FIG. 7 illustrates a design of the tissue positioning tool used experimentally; and

FIG. 8 shows an example of a prostate mounted and rotated in a tissue positioning tool and a resulting image based on four positions.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “microscopy” can refer to the field of using microscope objectives to view objects or specimens that are too small to be seen with the human eye. The term microscopy can encompass two dimensional microscopy, three dimensional microscopy, and the like. Examples of various microscopy techniques include, but are not limited to, structured illumination microscopy, light sheet microscopy, confocal microscopy, multiphoton microscopy, fluorescence microscopy, and the like.

As used herein, the term “intraoperative” can refer to something that is performed during the course of a surgical procedure.

As used herein, the term “automate” can refer to something operating using machines, computers, and the like, instead of people doing the work. For example, in an automated process, a person may press a button to start or end the process, but the process occurs automatically without input from the person.

As used herein, the term “sample” can refer to a specimen taken for scientific testing or analysis. For example, the sample can be a tissue sample that includes at least a portion of biological material.

As used herein, the term “surface” can refer to a portion of a sample being imaged. The term surface can include the traditional two dimensional external border of the sample (taken with a 2-dimensional microscope), a volume related to the border (which can extend 500 μm or less into the tissue sample) (taken with a 3-dimensional microscope), or the like.

As used herein, the terms “subject” and “patient” can be used interchangeably and refer to any warm-blooded organism that may be undergoing a surgical procedure. For example, a sample can be taken from a subject intraoperatively.

### II. Overview

Many surgical procedures that are used to remove cancerous tissue from a patient's body (e.g., radical prostatectomy) are ultimately unsuccessful. The failure of these surgical procedures often is due to a failure to remove every last bit of the cancerous tissue from the patient's body with even a small bit of cancer tissue left behind at the resection margin. However, an overly radical surgery can lead to complications, including impotence, incontinence, pain, and suffering. The only intraoperative technique to monitor the removal of the cancerous tissue is frozen section analysis (FSA), and the current gold-standard for such detection is post-operative formalin-fixed paraffin embedded (FFPE) permanent histopathology. Both FSA and FFPE tend to be labor and time intensive, as well as destructive. Microscopy (such as 2-dimensional surface microscopy, 3-dimensional volume microscopy, and the like) may be able to address the limitations of FSA and FFPE. Example types of microscopy can include, but are not limited to, structured illumination microscopy, light sheet microscopy, confocal microscopy, multiphoton microscopy, fluorescence microscopy, and the like. However, such microscopy has not been able to replace FSA and FFPE because of the requirement for manual sample re-positioning, causing time and accuracy limitations.

The present disclosure describes a sample positioning technique to facilitate microscopy (e.g., 2-dimensional microscopy, 3-dimensional microscopy, etc.). For example, the microscopy can be of the sample surface. In some instances, the sample positioning technique can enable intraoperative microscopy to become a reality. The sample can be attached to a tissue positioning device, and a microscope can take a plurality of microscopy images of a surface (e.g., a 2-dimensional surface, a 3-dimensional volume, or the like) of the sample in a rotational geometry using the tissue positioning device. After the sample is attached to the tissue positioning device, the tissue positioning device can work by precisely lifting, lowering, and/or rotating the tissue sample a fixed number of degrees in between image acquisitions. One advantage offered by the sample positioning technique is the ease of correlation between images and patient anatomy and tracking of features, such as nerves and vessels, around the circumference of the tissue.

### III. Systems

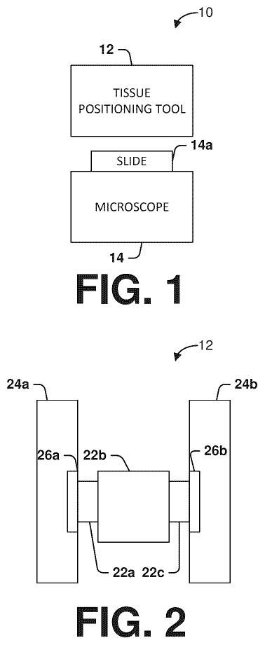

An aspect of the present disclosure can include a system 10 (FIG. 1) that can that can be used to position a sample to facilitate microscopy (e.g., 2-dimensional microscopy, 3-dimensional microscopy, etc.). While the sample can be any biological element requiring microscopy, as an example, the sample can include tissue excised from the patient's body (such a sample can be referred to as a “tissue sample”). The tissue can require testing to determine if a disease state occurs in the tissue (e.g., biopsy, surgical margin examination from a surgical procedure that is used to remove cancerous tissue from a patient's body, etc.). One example of such a surgical procedure is a radical prostatectomy, in which ensuring that the surgical margins are clean must be weighted with the loss of function.

The system 10 can be used for imaging the sample surface. It should be noted that the term “surface” can refer to a 2-dimensional surface, a three-dimensional volume (e.g., as many as 500 μm into the sample, such as less than 300 μm into the sample or less than 100 μm into the sample), or the like. The system 10 may be especially helpful when imaging a sample surface, at least partially eliminating the need for manual re-positioning of the sample to get different views of the sample surface.

At a minimum, the system 10 can include a tissue positioning tool 12 (also referred to as a tissue positioning device) and a microscope 14. In some instances, the sample can be stained before undergoing microscopy. Although not illustrated, a labeling component can exist that can ensure that the sample is labeled. Examples of labels can include (but are not limited to) nucleic acid stains, histo-chemical stains, antibodies, fluorescent labels, nanoparticles, or the like.

The microscope 14 can include all components necessary to take a microscopy image. For example, the microscope 14 can be used for structured illumination microscopy, light sheet microscopy, confocal microscopy, multiphoton microscopy, fluorescence microscopy, or the like. Common among the different types of microscopes is a slide 14a. The tissue positioning tool 12 can facilitate positioning at least a portion of a sample on the slide 14a. The positioning can be sequential with different portions of the sample being placed against the slide 14a to facilitate imaging the entire sample. For example, the positioning can be accomplished through at least rotating the sample, which may require at least raising and lowering the sample.

The tissue positioning tool 12 can include at least a tissue holding mechanism and a motorized mechanism. The tissue holding mechanism can hold at least a portion of the tissue sample. In some instances, the tissue sample itself can be attached to the tissue holding mechanism (e.g., at least a portion of the tissue holding mechanism can be placed through the sample and/or the attachment can be assisted by a clamp or other attachment mechanism). In other instances, the tissue sample can be placed into a device (e.g., like a cuvette), which can be attached to the tissue holding mechanism. The tissue holding mechanism can be a linear support device, for example, like a rod (which can be made of wood, metal, a combination of wood and metal, or the like).

The tissue holding mechanism can include at least two portions (e.g., end portions) that can be secured in joints of the motorized mechanism. The motorized mechanism can include at least one motor. For example, the at least one motor can be used to raise, lower, and/or rotate the tissue holding mechanism (so at least a portion of the sample can move). In some instances, the motorized mechanism can include a single motor. In other instances, the motorized mechanism can include two motors. In further instances, the motorized mechanism can include three or more motors. The motors can include, for example, a stepper motor, a linear actuator, or the like.

A top view of an example tissue positioning tool 12 (looking down) is shown in FIG. 2. The tissue holding mechanism 22a-c can extend between two sides of the motorized mechanism 24a, 24b. In an example, the tissue holding mechanism 22a-c can be at an angle, where one of the sides of the motorized mechanism 24a, 24b can be at different levels relative to one another. One or both sides of the motorized mechanism 24a, 24b can include one or more motors. A portion of the tissue holding mechanism 22a can interface with a joint 26a on one size of the motorized mechanism 24a. Another portion of the tissue holding mechanism 22c can interface with another joint 26b on the other side pf the motorized mechanism 24b. Each of the joints 26a, 26b can be configured to rotate. The center of the tissue holding mechanism 22b can be the portions where the sample is held. Indeed, the center of the tissue holding mechanism 22b need not be a different size than the two ends of the tissue holding mechanism 22a, 22c. In the example shown in FIG. 2, it appears as though the center of the tissue holding mechanism 22b is configured to receive a cuvette. However, the center of the tissue holding mechanism 22b could also be configured such that a sample could be attached thereto.

As the tissue positioning tool 12 rotates the sample to different positions on the slide 14a, the microscope 14 can image a field of view of the visible portion of the sample to create a series of images that can provide a visualization of at least a portion of the sample. For example, the microscope 14 can image a surface of the sample in a plurality of configurations. to provide a visualization of at least a portion of the sample. As an example, the visualization can provide a “rolled out” view (or flat view) of the sample. Advantageously, the “rolled out” view of the sample (or the surface of the sample) can allow for correlation between the sample (e.g., a tissue sample) and patient anatomy. For example, two imaging systems, such as an imaging system that takes 3-dimensional images of the sample surface topography and a microscope that images the microscopic detail of the surface of the sample, can image the sample, and the outputs of the two imaging systems can be correlated together.

In instances where the microscope 14 performs surface imaging, the tissue positioning tool 12 can ensure that the entire surface of the sample is imaged. The tissue positioning tool 12 can facilitate an at least partially autonomous rotation of the sample so that a portion of the sample surface is imaged for each rotation. The rotations can include a certain number of degrees that the motor is preprogrammed with. For example, the sum of the rotations can be a full 360 degrees with the number of rotations splitting the 360 degrees—like 4 rotations, 90 degrees apart. However, the number of rotations can be based on the size of the sample, a size of the field of view, a desired resolution, a desired imaging time, or the like. In some instances, the tissue positioning tool 12 can work in an autonomous manner with the only input from a human being pressing a button to start, for example. Autonomous operation can lead to a faster microscopy procedure with a reduced risk for areas of the sample surface being missed.

### IV. Methods

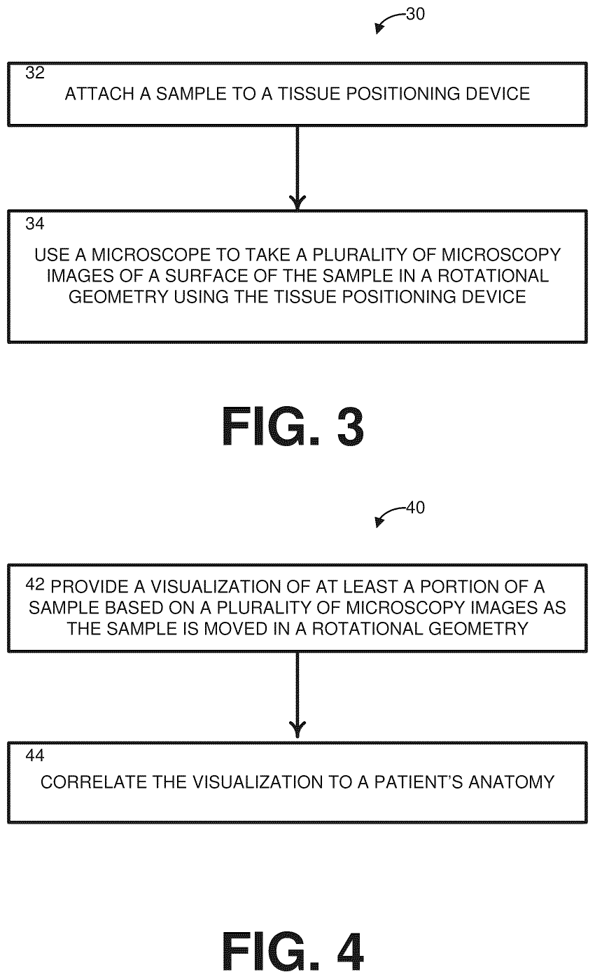

Another aspect of the present disclosure can include methods 30-60 for sample positioning to facilitate microscopy (e.g., 2-dimensional microscopy, 3-dimensional microscopy, etc.), as shown in FIGS. 3-6. The methods 30-60 can be executed using the system 10 shown in FIGS. 1 and 2.

For purposes of simplicity, the method 30 is shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 30-60, nor are the methods 30-60 necessarily limited to the illustrated aspects. Additionally, one or more of the steps can be stored in a non-transitory memory and accessed and executed by a processor.

Referring now to FIG. 3, illustrated is a method 30 for sample positioning to facilitate microscopy (e.g., 2-dimensional microscopy, 3-dimensional microscopy, etc.). At Step 32, a sample can be attached (e.g., a portion of the tissue positioning device can be placed through the sample, a clamp or other device can help to attach the sample to the tissue positioning device, the sample can be within a cuvette that can be attached to the tissue positioning device, etc.) to a tissue positioning device (e.g., tissue positioning device 12). At Step 34, a microscope (e.g., microscope 14, which can be used for two dimensional, three-dimensional, etc. imaging; for example, used for structured illumination microscopy, light sheet microscopy, confocal microscopy, multiphoton microscopy, fluorescence microscopy, etc.) can be used to take a plurality of microscopy images of a surface of the sample in a rotational geometry using the tissue positioning device. In some instances, the sample can be stained before or after the attachment. It should be noted that the tissue positioning device can include at least a tissue holding mechanism configured to hold at least a portion of the tissue sample (e.g., a linear support device, such as a rod); and a motorized mechanism, comprising at least one motor, configured to raise, lower, and/or rotate the tissue holding mechanism, where the tissue holding mechanism comprises at least two portions (e.g., two end portions) configured to be secured in joints of the motorized mechanism. One or more motors of the motorized mechanism can be configured to operate at least partially autonomously (e.g., in a manual mode) or substantially autonomously (e.g., in an automatic mode where the only input from a user can be starting or stopping the microscopy procedure).

Referring now to FIG. 4, illustrated is a method 40 for using microscopy images. At Step 42, a visualization of at least a portion of a simple can be provided based on a plurality of microscopy images as the sample is moved in a rotational geometry. At Step 44, the visualization can be correlated to a patient's anatomy. Although the correlation can occur in a number of ways, one example includes two microscopes, such as a microscope that takes 3-dimensional images of the sample surface topography and a microscope that images the microscopic surface detail of the sample, can image the sample, and the outputs of the two microscope can be correlated together.

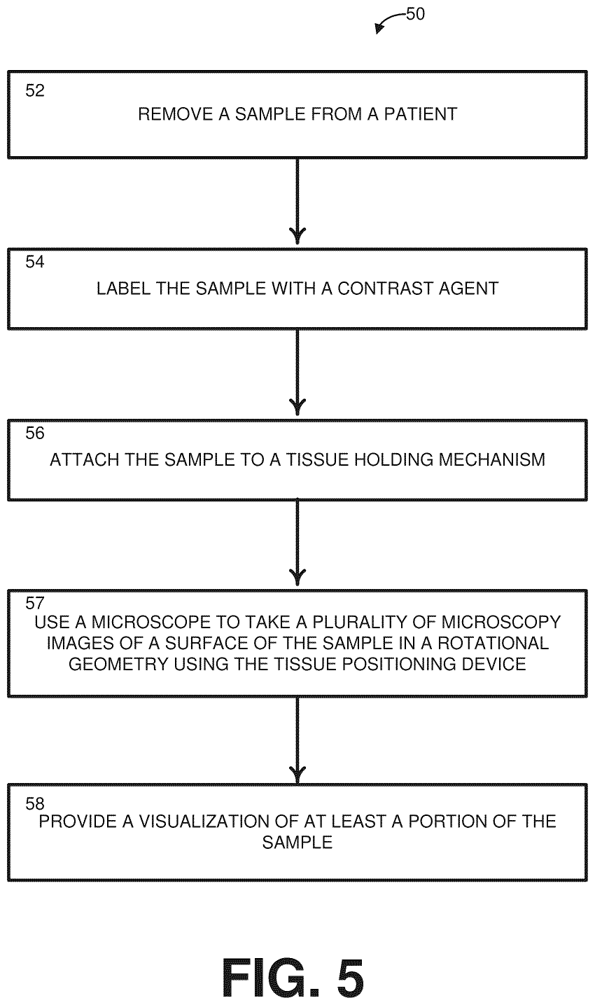

Referring now to FIG. 5, illustrated is a method 50 for imaging a labeled sample. At Step 52, the sample can be removed from a patient. At Step 54, the sample can be labeled with a contrast agent. Examples of labels/contrast agents can include (but are not limited to) nucleic acid stains, histo-chemical stains, antibodies, fluorescent labels, nanoparticles, or the like. At Step 56, the sample can be attached to a tissue holding mechanism. At Step 57, a microscope can be used to take a plurality of microscopy images of a surface of the sample in a rotational geometry using the tissue positioning device. At Step 58, a visualization can be provided of at least a portion of the sample.

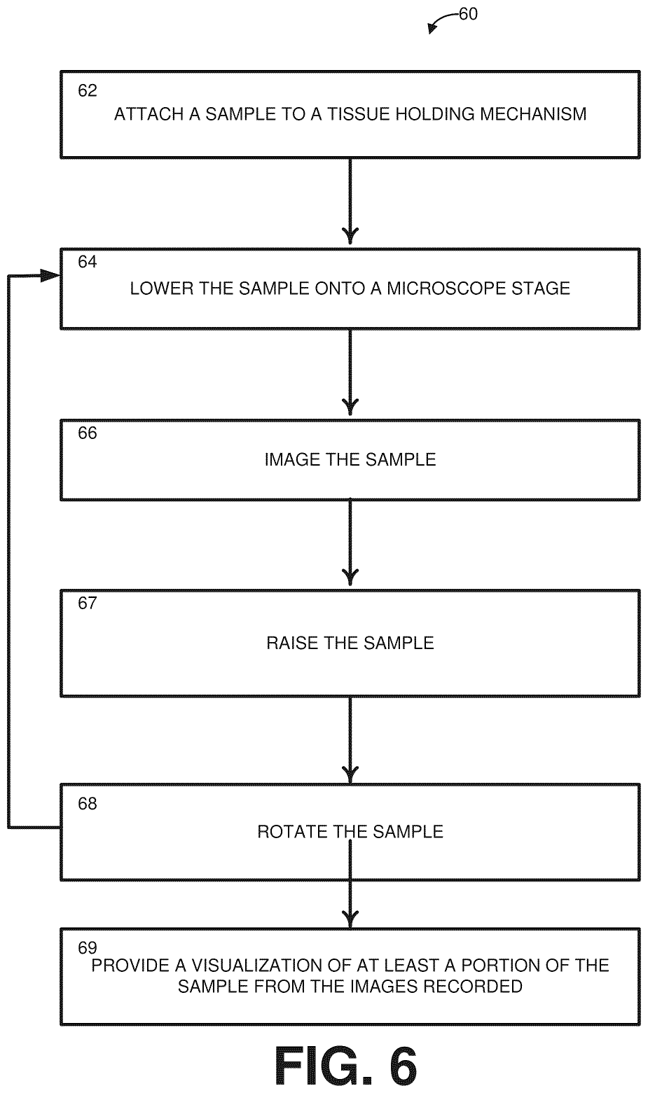

Referring now to FIG. 6, illustrated is a method 60 for performing microscopy. At Step 62, a sample (that can be taken from a patient) can be attached to a tissue holding mechanism. The tissue holding mechanism can lower the sample onto a microscope stage (Step 64), a microscope can image the sample (Step 66), the sample can be raised by the tissue holding mechanism (Step 67), and the sample can be rotated by the tissue holding mechanism (Step 68). Steps 64-68 can be repeated until the entire sample has been imaged. At 6, a visualization can be provided of at least a portion of the sample from the images recorded.

### V. Experimental

The following example shows the use of an example of the tissue positioning system described herein, referred to as the Automatic Prostate Positioning System (AAPS) in this Example, with video rate structured illumination microscopy (VR-SIM) to study the surface of a tissue sample from a prostatectomy. The following example is for the purpose of illustration only and is not intended to limit the appended claims.

### Methods

### Instrumentation

The VR-SIM system is constructed around an automated epi-fluorescence microscope platform (RAMM, Applied Scientific Instrumentation), which incorporates a 7 mm/s motorized XY specimen stage and a motorized Z objective positioner. Blue excitation light is provided by an LED (475 nm, Thorlabs). For data described in chapter 5, excitation light is provided by a 6-line (405/445/470/520/528/640 nm) multimode-fiber-coupled laser engine designed for wide-field imaging (LDI, 89 North). Excitation light is transmitted through a polarizing beam splitter and imaged onto a liquid crystal on silicon (LCoS) spatial light modulator (SLM, Model 3DM, Forth Dimension Displays). The excitation light is filtered and reflected into the imaging objective (Nikon, Plan Apo 10×0.45 NA) by a 500 nm edge dichroic mirror (FITC-Di01-Clin-25×36, Semrock), projecting the SLM-generated pattern onto the sample. Fluorescence from the sample is collected by the objective and transmitted through the dichroic mirror and a 515 nm longpass emission filter (FITC-LP01-Clin-25, Semrock). The image is collected by a scientific CMOS camera (Orca Flash 4.0 v2, Hamamatsu) at a full-frame resolution of 2048×2048 pixels with a pixel size of 6.5 μm (LDI—laser engine; BE—beam expander; CL—collimator; SLM—spatial light modulator; PBS—polarizing beamsplitter; P—polarizer; L—achromat lens; F—multiband filter; DBS—multiband dichroic beamsplitter; OL—objective lens; sCMOS—camera). Thus, at 10× magnification, the single-frame field-of-view is 1.3 mm×1.3 mm and the lateral resolution of the system is 1.3 m, in this case limited by the Nyquist criterion (0.65 m/pixel at the sample).

Synchronization and control of the LED, SLM, stage, objective, and camera is achieved via custom-written LabVIEW software (National Instruments) and home-built electronic triggering circuits. The VR-SIM module is mounted to the RAMM base and fits comfortably on a 24″×36″ passive isolation breadboard (Nexus, Thorlabs) mounted on a 3′×4′ wheeled lab bench (OnePointe Solutions).

### Image Acquisition

Intact prostates obtained from robotic radical prostatectomy procedures were brought directly from the operating room to the nearby imaging lab within 10 minutes of excision. The prostates were rinsed with PBS to remove excess blood or fluid from the surface, blotted dry with lab tissue, and fully-immersed in a beaker containing 0.5% acridine orange in phosphate buffered saline (PBS) for 30 seconds. Following the staining, the prostates were rinsed in a beaker containing PBS and again blotted dry. Specimens were then directly imaged with VR-SIM.

Specimens from the first 5 patients were used to optimize the imaging parameters of the VR-SIM system. Rather than attempting to image all surfaces of the prostate in the first set of patients, the objective for these cases was to finalize imaging settings to be used for all future specimens.

The next set of 49 patients was used to test clinical feasibility and potential utility, by focusing on circumferential surface imaging and identification of pathologically relevant features on the surfaces from the resulting images. For each specimen, the prostate surface was placed on a 75×50×1 mm glass slide and gentle pressure was applied so that the surface of the prostate adhered to the glass. The slide was then mounted on the stage of the VR-SIM system. No compression was applied to the prostate during imaging. Before imaging, the stage was manually adjusted such that the center of the tissue to be imaged was positioned above the objective. The objective was then moved in the z-direction until the tissue was properly focused. This focal distance was maintained for all images taken of one aspect of the prostate. After completely imaging one entire surface with VR-SIM, the specimen was manually rotated along the urethral axis and the imaging procedure was repeated four more times until the following approximate surfaces of the prostate (posterior, anterior, right lateral, left lateral, base) were imaged within a one-hour timeframe. Most often, only four aspects of the tissue were captured corresponding to the circumferential aspect, and the sample was manually rotated 90° between each acquisition.

### Image Mosaic Processing

Incoherent SIM is performed by projecting a sinusoidal pattern onto the sample, which is phase-shifted by one-third of the grid period between each of three sequential images. From these three patterned images, a single optically-sectioned image is obtained using the square-law detection algorithm.

$${I}_{SIM} = \sqrt{{( {x}_{1} - {x}_{2} )}^{2} + {( {x}_{1} - {x}_{3} )}^{2} + {( {x}_{2} - {x}_{3} )}^{2}}$$

where I_{SIM} is the recovered optically sectioned image, and x₁, x₂, and x₃ are the three sequential patterned images, respectively.

Mosaics of the stained tissue were collected using a serpentine scan approach. Each individual frame in the mosaic was first intensity-normalized, and then corrected for non-uniform illumination (i.e. flat field correction) by dividing by an intensity-normalized reference image taken of a fluorescent calibration slide (Chroma). To maximize the area-throughput, there was no overlap between adjacent images during collection, and mosaics were constructed without the use of stitching algorithms. The processed images were re-scaled to restore them to 16-bit grayscale intensity and saved as full resolution TIFF or BigTIFF format. The images were then subsequently converted to multi-resolution tiled pyramidal TIFF or BigTIFF format using nip2 software.

### Surface Area of VR-SIM Images

The absolute tissue surface area coverage achieved by VR-SIM for each prostate was obtained by performing a binary threshold analysis of grayscale VR-SIM images. All threshold analyses were performed in MATLAB using Otsu's method to convert from grayscale to binary images. Otsu's method, when implemented in MATLAB, chooses the threshold to minimize the intraclass variance of the black and white pixels, that is, it looks to place the cutoff between ‘white’ and ‘black’ at a position that clusters the two groups based on similar intensities. This has the benefit over setting the threshold halfway between the minimum and maximum intensities, which may lead to the exclusion of less intense, but useable, data. The segmented image can be adjusted by a scaling factor to lower or raise the threshold. The resulting image represents a mask differentiating those pixels which contain tissue versus those that do not, enabling a calculation of tissue surface area from the grayscale image. Grayscale images in MATLAB are 16-bit, that is each pixel can take on a value from 0 to 65535 (2¹⁶). As the threshold is raised, fewer and fewer pixels are kept for the binary image. The green box indicates the binary threshold, and resulting binary image, that corresponds well with the original grayscale image.

Rather than considering individual tiles comprising the tissue image mosaics, the full image mosaics of each surface aspect of the prostate were used for this analysis. This allows MATLAB to treat each pixel in the image as a number in an array. For a binary image, the number will be 1 or 0. By taking the sum of this binary array and dividing it by the number of elements in the array, the percentage of pixels that make up “tissue containing” data can be determined. Multiplying this percentage by the total number of pixels in the original grayscale image, the number of pixels that contain in focus data is determined. Multiplying this value by the area of an individual pixel, 0.425 μm², the surface area of relevant data for the original VR-SIM image is determined.

### Total Surface Area of Radical Prostatectomy Specimens

Excised prostates vary greatly in dimension from patient to patient, both in terms of size and shape. Therefore, the surface area must be measured for each individual patient, yet the prostate is bulky and irregular, thus surface area approximations such as spherical or ellipsoidal from simple length measurements, are not accurate. To obtain the actual surface area of the prostate to compare with VR-SIM images, a structured-light 3D scanner was used. 3D scans of excised prostates were achieved using a DAVID-SLS-2 3D scanner. During scanning, tissue specimens were placed on an automatic 360° turntable which allows the scanner to cover all parts of the tissue surface. The scanner, which consists of a structured light projector and a CMOS camera, is mounted on an articulating arm, so that the appropriate angle and course focal distance could be adjusted for each scan. The scanner employs structured light technology; a series of patterns of varying spatial frequencies are projected onto the tissue, and images are taken of each pattern frequency. Based on how the patterns interact with the topography of the tissue surface, the 3D scanning software determines the topography of the tissue and meshes the series of images into a solid surface. Surface images are collected at each rotation of the sample until the entire circumference is imaged, and the resulting surfaces are meshed into a single 3D color surface rendering. This meshed image is saved and exported to a 3D visualization software, MeshLab, a software platform for data visualization, processing, and analysis. Using MeshLab, the surface area of the 3D scanned prostate is determined.

### VR-SIM Percent Surface Coverage

To determine the percent surface area coverage obtained using VR-SIM, all binary threshold analyses for a particular case were combined and this value was divided by the total surface area as determined by the 3D scan.

Seminal vesicles and ductus deferens, which extend from the base of the prostate, are not used in the post-operative diagnosis of circumferential surgical margins using slide-based pathology. For this reason, 3D scans were manually altered to remove ductus deferens and seminal vesicles, and total surface area of VR-SIM data were also calculated without the inclusion of the seminal vesicles or ductus deferens. MATLAB code used to perform the binary threshold analysis can be found in the supplementary information section.

### Conceptual Approach to Reducing Total Imaging Time

In consideration of the long-term goal of having a VR-SIM system in the operating room performing intraoperative analysis of surgical margins, it is obligatory that imaging time be reduced as much as possible while maximizing tissue coverage. An additional goal is for the process to be completely automated, such as to minimally interfere with current intra-operative workflows. To this end, we have developed a novel Automatic Prostate Positioning System (APPS) to eliminate the need for human input once the imaging process has begun. This device uses the natural location of the urethra through the long axis of the prostate to conveniently manipulate the prostate rotationally, and stepper motors to lift, rotate, and lower the prostate between image acquisitions. This reduces imaging time because the entire organ circumference is systematically sampled using small precise rotation steps, eliminating the need to manually find the outer edge of the prostate in contact with the microscope slide. It also has the added benefit of increasing tissue surface-glass contact over the imaging plane, eliminating the need for autofocus to track rough tissue topography.

### Image Reproducibility

One critical function is the ability to reproduce similar images of the same area of tissue after several raise-lower cycles. To confirm this, a 1.56×2.60 cm area of tissue was imaged four times, raising and lowering the tissue in between capturing images. By showing that subsequent images taken in between raising and lowering the tissue are similar, we can say that the imaging is independent of the lifting and rotating process and only relies on the area of tissue in contact with the slide.

VR-SIM Image Acquisition using the APPS

Intact prostates obtained from robotic radical prostatectomy procedures were brought directly from the operating room to the nearby imaging lab within 10 minutes of excision. The prostates were rinsed with PBS to remove excess blood or fluid from the surface, blotted dry with lab tissue, and fully-immersed in a beaker containing 0.5% acridine orange in phosphate buffered saline (PBS) for 30 seconds. Following the staining, the prostates were rinsed in a beaker containing PBS and again blotted dry. A wooden dowel rod is then placed through the prostatic urethra and secured with custom fabricated clamps (discussed in 5.3.1, Prototyping). The prostate with dowel rod in place is then mounted in the APPS system and the tissue is imaged with VR-SIM.

### VR-SIM+APPS Image Mosaic Processing

Mosaics of VR-SIM images captured of the prostate surface while using the APPS were processed the same way non-APPS images were. Rather than displaying all aspects in different images, however, margins captured using the APPS are displayed in one continuous strip or ‘rolled out’ view.

### Total Imaging Time

The time between the beginning and end of the imaging protocol was also recorded, that is when the first and last images were taken. This figure does not include pre-imaging steps such as staining and mounting in the APPS.

This new imaging protocol results in a ‘rolled out’ view of the prostate instead of four separate images, allowing for ease of correlation between excised tissue, images, and patient anatomy. In addition, by increasing the number of aspects taken of the prostate, we increase imaged surface area. Consider now a circle inscribed in a decagon. The decagon represents the field of view of the mosaic images collected for the tissue circumference using the new imaging protocol. Notice that the width of the imaging field for any one prostate orientation has been reduced, such that system covers the full length but only a fraction of the circumference in contact with the slide at any given time. By precisely orienting the prostate over multiple rotations and imaging a predefined tissue width based on the tissue circumference at each rotation, we ensure that no aspect of the circumference goes unimaged, increasing imaged surface area coverage of the margin.

An accepted time frame for intra-operative FSA is approximately 20-30 minutes. Therefore, the goal of the APPS is to allow for the imaging of the full circumferential margin in this same timeframe.

### Device Design—Functional Requirements

The device must reduce the time required to image the entire circumferential surgical margin to under 20 minutes, the amount of time required to perform one frozen section analysis.

The device must cover a larger surface area of the prostate than the previous manual rotation method.

The device must fit within the footprint of, and attach to, the 28×16 cm VR-SIM microscope stage and must not interfere with stage movement.

The device must be made of inexpensive materials to allow for multiple rounds of prototyping

The device must not damage the surface of the prostate gland.

### Device Design—Prototyping Resources

All 3D modeling of device components was performed in Solidworks. Components were printed on MakerBot brand 3D printers provided by the Tulane Makerspace. Stepper motors and other electronic components were controlled with an Arduino.

### Device Design—Calculating Width of Imaging Panel per Rotation

To reduce human input, the number of aspects or “panel” images taken of the prostate, or the number of times the tissue is rotated, is held constant. The number of aspects and the diameter of the prostate sample determines the width of each ‘panel’. A larger prostate will require more frames per panel width to cover the entire circumference in ten rotations, compared to a prostate of smaller diameter. The equation to calculate the width of each panel required to capture the full circumferential margin in ten rotations is simply the arc length of a 36° angle on a prostate with diameter, d:

$$Arc length = π d ( \frac{C}{360} )$$

Where C is the central angle of the arc in degrees, again, 36° in this case. The equation becomes:

$$Width of imaging panel = \frac{π d}{10}$$

Before imaging begins, the diameter of the prostate is measured to the nearest millimeter using a ruler (rounding up) to determine the width of each panel. The length of each panel is measured to be the straight line distance from the base to the apex of the prostate, also measured using a ruler to the nearest millimeter, rounding up.

### Results

### Surface Area of VR-SIM Images

Combining the surface areas of all images provided the total surface area covered by all VR-SIM images, which was 47.8 cm² for this particular prostate. There is good correlation between tissue coverage in the grayscale SIM images and white pixels in the binary images. The surface areas of all specimens evaluated in this study can be viewed in Table 1. Only specimens that were successfully imaged on at least four sides are included (n=33).

TABLE 1
VR-SIM surface area coverage of radical prostatectomy specimens by case. Only
cases where at least four sides were successfully scanned have been included.

| | Imaged Area (cm²) | | | | | |
|---|---|---|---|---|---|---|
| Case Number | Anterior | Posterior | Left | Right | Base | Total |
| 6 | 9.31 | 16.31 | 17.41 | 4.75 | | 47.78 |
| 7 | 9.19 | 7.82 | 5.37 | 4.86 | | 27.25 |
| 8 | 3.55 | 8.42 | 5.16 | 5.37 | 2.36 | 24.85 |
| 9 | 6.19 | 1.87 | 4.32 | 2.26 | 8.04 | 22.67 |
| 11 | 6.63 | | 6.44 | 6.40 | 10.09 | 29.56 |
| 12 | 6.02 | 11.82 | 5.16 | 2.60 | | 25.60 |
| 13 | 0.56 | 7.71 | 1.43 | 2.12 | | 11.82 |
| 14 | 7.03 | 13.78 | 5.75 | 6.70 | | 33.25 |
| 15 | 3.63 | 10.28 | 4.61 | 7.72 | | 26.23 |
| 16 | 5.94 | 8.62 | 5.21 | 4.96 | | 24.74 |
| 17 | 3.01 | 10.34 | 1.58 | | 3.45 | 18.39 |
| 18 | 5.83 | 7.86 | 5.14 | 5.17 | | 23.99 |
| 19 | 4.98 | 4.29 | 5.72 | 2.82 | | 17.81 |
| 20 | 5.41 | 9.35 | 8.03 | 5.33 | | 28.12 |
| 22 | 5.10 | 7.98 | 7.52 | 8.03 | | 28.63 |
| 23 | 6.12 | 8.16 | 5.88 | 5.92 | | 26.08 |
| 24 | 6.16 | 8.10 | 7.79 | 6.11 | | 28.17 |
| 25 | 3.05 | 5.03 | 1.92 | 2.62 | | 12.62 |
| 26 | 5.30 | 4.69 | 0.16 | 4.47 | | 14.62 |
| 27 | 3.86 | 5.95 | 5.58 | 6.20 | 0.40 | 21.99 |
| 28 | 2.88 | 6.61 | 3.71 | 5.63 | | 18.84 |
| 29 | 3.28 | 6.44 | 3.95 | 4.40 | | 18.07 |
| 30 | 4.82 | 7.03 | 4.71 | 8.63 | | 25.19 |
| 31 | 3.77 | 4.20 | 1.66 | 2.62 | | 12.25 |
| 33 | 3.48 | 6.99 | 4.28 | 2.05 | | 16.80 |
| 38 | 6.17 | 8.52 | 3.68 | 6.10 | | 24.48 |
| 40 | 4.22 | 11.35 | 5.36 | 7.04 | | 27.97 |
| 41 | 5.21 | 7.30 | 4.55 | 5.31 | | 22.36 |
| 42 | 4.26 | 8.60 | 6.35 | 5.93 | | 25.14 |
| 43 | 6.71 | 10.48 | 4.91 | 7.82 | | 29.92 |
| 44 | 4.33 | 6.84 | 6.02 | 6.00 | | 23.20 |
| 45 | 4.56 | 7.25 | 4.39 | 5.12 | | 21.33 |
| Average | | | | | | 23.74 ± 6.88 cm² |

### Total Surface Area of Radical Proctectomy Specimens

Information flows from the prostate being 3D scanned, stitching in the 3D scanner software, and surface area determination in MeshLab. Table 2 shows 3D scanned prostate surface area, SIM image surface area, and traditional slide-based pathology surface area. Slide based pathology involves cutting the prostate into quadrants, sectioning these quadrants into 3 mm thick blocks, and shaving a 4 μm thick slice from each block. For this reason, the maximum percent surface coverage that can be obtained using this method is 4 m out of every 3000 m, or 0.133%. Since measuring the exact linear margin on every pathology slide generated from a radical prostatectomy is impractical, the surface coverage of specimens obtained using slide based pathology was assumed to be at best 0.133% of the total surface area obtained using the 3D scanner.

TABLE 2
Comparison of SIM image surface area, 3D scan surface area, and slide-based pathology surface area.
Only cases when the prostate was successfully scanned on at least four sides and then
successfully 3D scanned are included.

| | | | VR-SIM | |
|---|---|---|---|---|
| | | | percent | Slide based |
| | VR-SIM | 3D scan | surface | pathology |
| Case | image area | surface area | coverage | surface area |
| Number | (cm²) | (cm²) | (%) | (cm²) |
| 21 | 18.58 | 96.90 | 19.17 | 0.13 |
| 22 | 28.63 | 86.16 | 33.23 | 0.11 |
| 25 | 12.62 | 57.20 | 22.07 | 0.08 |
| 26 | 14.62 | 59.10 | 24.73 | 0.08 |
| 27 | 21.99 | 64.60 | 34.03 | 0.09 |
| 28 | 18.84 | 68.80 | 27.38 | 0.09 |
| 30 | 25.19 | 76.48 | 32.93 | 0.10 |
| 31 | 12.25 | 65.77 | 18.63 | 0.09 |
| 33 | 16.80 | 56.7 | 29.63 | 0.08 |
| 38 | 24.48 | 71.64 | 34.17 | 0.10 |
| 40 | 27.97 | 64.12 | 43.62 | 0.09 |
| 41 | 22.36 | 66.72 | 33.51 | 0.09 |
| 42 | 25.14 | 55.21 | 45.53 | 0.07 |
| 43 | 29.92 | 54.44 | 54.95 | 0.07 |
| 44 | 23.20 | 58.04 | 39.97 | 0.08 |
| 45 | 21.33 | 70.64 | 30.19 | 0.09 |
| Average | 21.49 ± 5.32 cm² | 67.03 ± 11.31 cm² | 32.73 ± 9.48% | 0.09 ± 0.02 cm² |

While the binary threshold analysis was performed on all VR-SIM images captured up to this point, comparison of VR-SIM data and 3D scan data was only considered for cases that were imaged with VR-SIM and successfully 3D scanned (n=16). The average VR-SIM image total surface area for these cases was 21.49 cm², the average 3D scan surface area was 67.03 cm², and the average VR-SIM percent surface coverage was 32.73%. Compared to traditional pathology methods which cover 0.13% of the surface area of the prostate, VR-SIM represents a nearly 250-fold increase in surface area coverage.

Surface area of VR-SIM images of all radical prostatectomy cases through case number 45 that were successfully imaged on at least four sides can be viewed in Table 1. The average VR-SIM surface area coverage for all cases was 23.74 cm².

### APPS—Device for the Reduction of Total Imaging Time

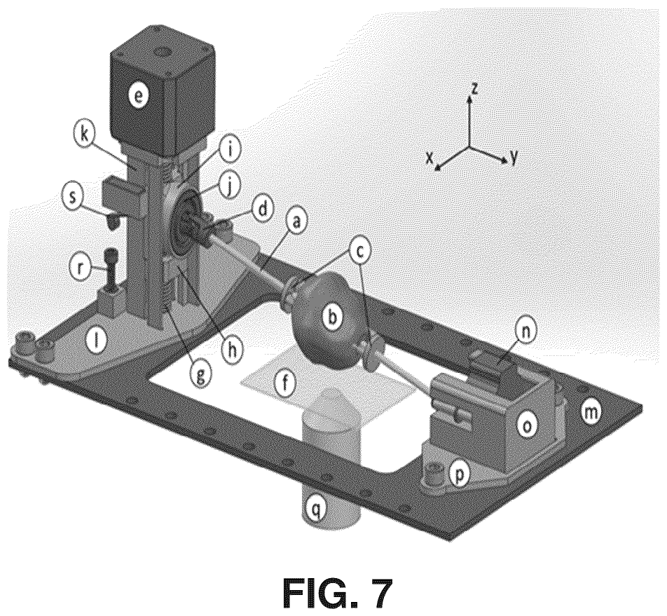

With the device, pictured in FIG. 7, before imaging begins, a wooden dowel rod (a) (d=3 mm) was placed through the prostatic urethra. The prostate (b) was held in place on the dowel rod with 3D printed clamps (c) that were press-fit onto the rod. The ends of the dowel rod were secured in gimbal joints (d) with set screws. Stepper motor 1 (e) lowered the prostate tissue onto a 50×75 mm glass slide (f) which was secured in stage clamps (not pictured). To lower the prostate onto the slide, stepper motor 1 turns a threaded rod (g) which engaged a nut (not pictured) that is prevented from spinning by a 3D printed housing (h). By preventing the screw from spinning, axial motion is produced as the ‘fixed-nut’ component moves up and down in the z-direction as the threaded rod rotates about the z-axis. On top of the fixed-nut housing rests the free-floating bearing housing (i) which the threaded rod did not engage. The bearing (j) inner diameter engaged the gimbal joint with a press fit. The threaded rod, fixed-nut housing, and bearing housing all reside in the 3D printed tower (k) which was fastened to stepper motor 1 via screws. The tower and internal components were attached to the tower via the mounting plate (l) which was attached to the stage (m) with screws. A second gimbal joint connects stepper motor 2 (n) to the other end of the dowel rod. Stepper motor 2 was responsible for the rotation of the dowel rod and therefore the prostate. Changing heights of the bearing housing resulted in a changing distance from stepper motor 2 to the base of the tower. This was compensated for by allowing stepper motor 2 to slide in its 3D printed housing (o) as the prostate is raised and lowered. The stepper motor 2 housing is attached to the stage via the 3D printed stepper motor 2 housing base plate (p). During image acquisition, the stage moves in the xy-plane in a serpentine pattern above the objective (q) to cover the desired surface area. When the imaging was complete, stepper motor 1 activated, raising the tissue, followed by stepper motor 2, rotating the tissue, followed by stepper motor 1 in the opposite direction, lowering the tissue back onto the slide for the next image acquisition. Prior to the first image being taken, a thumb-screw (r) is adjusted such that a microswitch (s), which is attached to the floating bearing housing, is triggered as the prostate contacts the slide and rests under its own weight. The microswitch interrupts the lowering of the prostate and begins a new image acquisition. The microscope slide booster is not pictured in this case.

The device has two operating modes: manual and automatic. While in manual, stepper motors are controlled by three separate buttons: raise, lower, and rotate. The stepper motor used to raise and lower the tissue will spin as long as the raise or lower button is pressed, but the stepper motor that rotates the tissue will spin 36° with one button press and will pause in between rotations. This gives the user total control over the device. A microswitch which allows for automatic operation of the APPS. When in automatic mode, a fourth button, ‘GO’, is used to begin the protocol. Stepper motor 1 (SM1) is started in the raised position, the ‘GO’ button causes SM1 to lower the tissue. The microswitch acts as a ‘STOP’ command for SM1, meaning that the motor will continue to lower the tissue until the microswitch is triggered. The height at which the microswitch is triggered can be adjusted with a thumb screw placed beneath the microswitch. This allows the user to adjust the position to which the prostate is lowered depending on the radius of the prostate.

Two minor components were fabricated to aid in the imaging process. First, prostate tissue clamps are used to hold the prostate in place on the dowel rod as it spins. Without the clamps, the dowel rod spins in the prostatic urethra and the prostate remains in place. Second, a microscope slide booster, is used to raise the microscope slide off of the stage when imaging particularly small prostates. This is so that the tissue makes full contact with the microscope slide. The component mounts to the stage in the same way a normal microscope slide would.

### Device Testing

To ensure that images captured while using the APPS are independent of the lifting and rotating procedure and rely only on the area of tissue in contact with the slide, an experiment was performed in which a prostate was stained, mounted on the APPS, and imaged repeatedly. A 12×20 frame area, corresponding to a 1.56×2.60 cm area, was imaged four times, lifting and lowering the tissue using the APPS in between each image acquisition. Images from this experiment were compared qualitatively, as there was a strong correlation between each subsequent image mosaic.

### Circumferential Prostate Margin

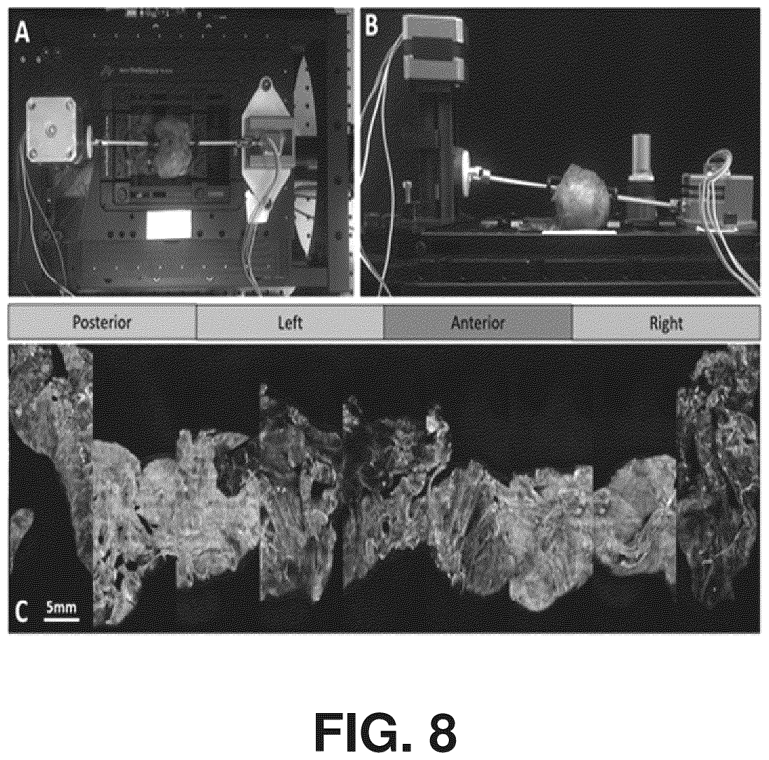

To date, 5 radical prostatectomy circumferential surgical margins have been imaged using the APPS, 3 of which were used to finalize design requirements and code. FIG. 8 show a prostate mounted on the system ready to be imaged (A and B) and the corresponding resulting image (C). Approximate locations of posterior, left, anterior, and right are indicated.

Table 3 contains data on total imaging time, total imaged area, and total imaged area as a percentage of surface area coverage using the APPS compared with average surface area coverage when using the previous manual 900 rotation method.

TABLE 3
All prostates imaged using the VR-SIM system coupled with the APPS.
Summary of prostate cased imaging using the APPS. Surface area as a
percentage of the previous method was determined by comparing average
surface area coverage achieved using the 90° rotation method
compared to the APPS surface coverage.

| | | | | Surface Area as |
|---|---|---|---|---|
| | Time to | Number | Surface | Percentage of |
| Case | Image | of panels | Area | Previous Method |
| Number | (minutes) | scanned | (cm²) | (%) |
| 55 | Used in image repeatability study | | | |
| 57 | 39 | 9 | 26.63 cm² | 112% |
| 58 | 32 | 10 | 30.64 cm² | 129% |

A summary of old and new tissue handling procedures compared to the new method in terms of surface area, surface coverage, and imaging time can be seen in Table 4.

TABLE 4
Summary of old and new tissue handling methods. Comparatively, the APPS enables
the imaging of more tissue surface area while simultaneously reducing imaging time.

| | Old handling method | | | New Handling method | | |
|---|---|---|---|---|---|---|
| Average Surface | | | Imaging | | | Imaging |
| area of 3D Scanned | Surface area | Surface | time | Surface | Surface | time |
| Prostate (cm²) | (cm²) | Coverage (%) | (minutes) | area(cm²) | Coverage (%) | (minutes) |
| 67.03 cm² | 21.49 ± 5.32 cm² | 32.73 ± 9.48% | 49 ± 13 | 28.64 ± 2.01 cm² | 42.72 ± 2.99% | 36 ± 4 |

Comparatively, the APPS increases surface area coverage by approximately 10% while reducing the time to image by over 25%. The average surface area of the 3D scanned prostates from the surface area study (chapter 3) is assumed to be representative of all prostates used in this study because prostates imaged using the APPS were not 3D scanned.

One variable introduced as a result of displaying images of surgical margins in one continuous strip is the orientation and positioning of the images, or image registration.

Registration between adjacent panels can be achieved by marking the circumferential surface of the tissue with histological ink prior to imaging. These fiducial markers can be used in post imaging processing to align each panel in the x and y directions. This can produce a more cohesive or contiguous view of the surgical margin. Stencils were used to ensure uniform fiducial markings. Using a laser cutter, thin sheets of transparent plastic were cut into stencil “bands” that can be wrapped around the prostate and used as a guide when painting on fiducial markings using a small paint brush.

Using the painted-on fiducial markers as a guide, the images can be aligned along the central line and spread out such that the distance between cross hatches on adjacent panels is equal to the spacing on the stencil. The distance between cross hatches on the stencil used to mark the tissue was 10 mm. This value corresponds well to the measured distance of cross hatches in the image, 10.63 mm. The total VR-SIM surface coverage in this case was 55.76 cm², which corresponds to 62% of the circumferential area of the cylinder (d=5.5 cm, h=5.2 cm). The reason for discrepancy between imaged area and circumferential area was the limited FOV that was captured in this experiment. The purpose of this test was to image the fiducial markers near the center of the circumference of the cylinder, not to image the full tissue.

From the above description, those skilled in the art will perceive improvements, changes and modifications. Such improvements, changes and modifications are within the skill of one in the art and are intended to be covered by the appended claims.

The following is claimed:

1. A system comprising:
a tissue positioning device comprising:
a tissue holding mechanism configured to hold at least a portion of a tissue sample; and
a motorized mechanism, comprising at least one motor, configured to raise, lower, tilt, and/or rotate the tissue holding mechanism,
wherein the tissue holding mechanism comprises at least two portions configured to be secured in joints of the motorized mechanism; and
a microscope configured to image a surface of the tissue sample in a plurality of configurations to provide a visualization of at least a portion of the tissue sample.

2. The system of claim 1, wherein the plurality of configurations of the tissue sample imaged by the microscope provide images of the surface of at least the portion of the tissue sample in a rotational geometry.

3. The system of claim 1, wherein the visualization comprises a composite view of a surface of the tissue sample.

4. The system of claim 1, wherein the tissue holding mechanism comprises a linear support device.

5. The system of claim 4, wherein the linear support device comprises a rod configured to be placed through the sample and/or to anchor the sample to the tissue holding mechanism, and wherein the at least two portions comprise two end portions of the rod.

6. The system of claim 5, wherein the tissue holding mechanism comprises at least one clamp and/or cuvette configured to secure the tissue sample to the rod.

7. The system of claim 1, wherein the microscope is used for structured illumination microscopy, light sheet microscopy, confocal microscopy, multiphoton microscopy, and/or fluorescence microscopy.

8. The system of claim 1, wherein the tissue sample is stained with a contrast agent before attachment to the tissue holding mechanism.

9. The system of claim 1, wherein the at least one motor comprises at least one stepper motor and/or at least one linear actuator.

10. A tissue positioning device comprising:
a tissue holding mechanism configured to hold at least a portion of a tissue sample; and
a motorized mechanism, comprising at least one motor, configured to raise, lower, tilt, and/or rotate at least a portion of the tissue holding mechanism,
wherein the tissue holding mechanism comprises at least two portions configured to be secured in joints of the motorized mechanism.

11. The tissue positioning device of claim 10, wherein the at least one motor operates in a manual mode or an automatic mode.

12. The tissue positioning device of claim 10, wherein the motorized mechanism is configured to rotate the tissue holding mechanism to expose the surface of at least the portion of the tissue sample to a microscope to take a plurality of microscopy images, wherein a visualization of the tissue sample based on at least a portion of the microscopy images comprises a composite view of a surface of the tissue sample.

13. The tissue positioning device of claim 10, further comprising a linear support device.

14. The tissue positioning device of claim 13, wherein the linear support device comprises a rod configured to be placed through the sample and/or to anchor the sample to the tissue holding mechanism, and
wherein the at least two portions comprise two end portions of the rod.

15. The tissue positioning device of claim 14, wherein the tissue holding mechanism comprises at least one clamp and/or cuvette configured to secure the tissue sample to the rod.

16. A system comprising a tissue positioning device adapted for use with a microscope controlled by a controller comprising a processor, wherein the processor is configured to:
receive a plurality of microscopy images of a surface of a tissue sample as the tissue sample is moved in a rotational geometry by a tissue positioning device; and
construct a composite view of the surface of the tissue sample based on at least a portion of the plurality of microscopy images.

17. The system of claim 16, wherein the processor is further configured to provide a visualization of the composite view, wherein the visualization allows for correlation between a composite view of a surface of the sample and patient anatomy.

18. The system of claim 16, wherein the plurality of microscopy images are two dimensional images and/or three dimensional images.

19. The system of claim 16, wherein at least a portion of the tissue sample is held by a portion of the tissue positioning device.

20. The system of claim 16, wherein the plurality of microscopy images comprises a series of images created as the tissue sample is moved by at least one motor, configured to raise, lower, tilt, and/or rotate at least a portion of the tissue positioning device.
